(19) United States
(12) Patent Application Publication
(10) Pub. No.: US 2010/0329278 A1
(43) Pub. Date: Dec. 30, 2010

(54) APPARATUS FOR SELECTING OPERATING TIME SLOT IN MESH NETWORK

(75) Inventors: Noseong Park, Daejeon (KR); Yoonmee Doh, Daejeon (KR); Hyunhak Kim, Daejeon (KR); Zhiying Yao, Daejeon (KR); Sung-Joong Kim, Daejeon (KR); Perkins Mattew, Sunrise, FL (US)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon (KR); Motorola Inc., Schaumburg, IL (US)

(21) Appl. No.: 12/668,115

(22) PCT Filed: Jul. 14, 2008
(86) PCT No.: PCT/KR08/04135

§ 371 Date: Jan. 7, 2010

(30) Foreign Application Priority Data
Jul. 13, 2007 (KR) 10-2007-0070882
Nov. 1, 2007 (KR) 10-2007-0111207

(51) Int. Cl. H04L 12/43

(52) U.S. Cl. 370/461; 370/458

(57) ABSTRACT

An access communication node which connects to a mesh network including a plurality of communication nodes, the access communication node including: a receiving unit receiving first operation slot information of a first communication node and second operation slot information of a second communication node from the first communication node capable of directly transmitting data to the access communication node, the second communication node being capable of directly transmitting data to the first communication node and incapable of directly transmitting data to the access communication node; a slot selection unit selecting an operation slot of the access communication node based on the first operation slot information and second operation slot information; and a slot information transmission unit transmitting operation slot information about the selected operation slot to the first communication node.

### TECHNICAL FIELD

The present invention relates to a communication apparatus operated in a mesh network, and more particularly, to a communication apparatus which selects a time slot transmitting or receiving data.

### BACKGROUND ART

A sensor network provides a service such as monitoring, pursuit, reconnaissance, automation, and the like using a plurality of communication nodes having a sensing, processing, and communication function. Companies and organizations around the world formed the Zigbee Alliance to configure a sensor network, and to try to embody a low-power and high-efficiency wireless network based on Institute of Electrical and Electronics Engineers (IEEE) 802.15.4 standard.

A plurality of communication nodes configuring a sensor network is generally operated using a battery due to the limited size and shape. A sensor network is required to be operated with minimum power for as long as possible due to the difficulty of maintenance and management.

As opposed to a point-to-point communication and a point-to-multipoint communication in a conventional art, a method which may configure a reliable communication network with low-power using a mesh network has been provided to configure a sensor network. Communication nodes configuring a mesh network are deactivated during most of a life cycle of a communication node to reduce power consumption, and receives/transmits data for a particular period of time.

A node transmitting data and a node receiving data are required to be operated at the same time so that a plurality of communication nodes configuring a mesh network transmits data. Accordingly, an access communication node connecting to a mesh network is required to select an operation time duration which does not collide with an operation time duration of a communication node which has been already connected to a mesh network and transmits data.

Also, when a plurality of transmission nodes transmits data to a specific receiving node, data collides, and thus the receiving node may not receive data. Accordingly, each communication node configuring a mesh network is required to report about information concerning a selected operation time duration to another communication node.

An access communication node connecting to a mesh network is required to select an operation time duration which does not collide with an operation time duration of a communication node included in a mesh network, and transmit information about the selected operation time duration to the communication node included in the mesh network.

A technology enabling an access communication node connecting to a mesh network to select an operation time duration which does not collide with an operation time duration of a communication node included in a mesh network is required. However, a practical technology of selecting an operation time duration has not been provided.

Thus, according to the present invention, a method of selecting an operation time duration for an access communication network connecting to a mesh network is provided. The method according to the present invention is applied in IEEE 802.15 standard.

### DISCLOSURE OF INVENTION

### Technical Problem

The present invention provides an access communication node which connects to a mesh network, selects an operation time duration which does not collide with an operation time duration of a communication node included in the mesh network, and transmits information about the selected operation time duration to the communication node included in the mesh network.

### Technical Solution

According to an aspect of the present invention, there is provided an access communication node which connects to a mesh network including a plurality of communication nodes, the access communication node including: a receiving unit receiving first operation slot information of a first communication node and second operation slot information of a second communication node from the first communication node capable of directly transmitting data to the access communication node, the second communication node being capable of directly transmitting data to the first communication node and incapable of directly transmitting data to the access communication node; a slot selection unit selecting an operation slot of the access communication node based on the first operation slot information and second operation slot information; and a slot information transmission unit transmitting operation slot information about the selected operation slot to the first communication node.

According to an aspect of the present invention, there is provided a communication node included in a mesh network, the communication node including: an operation slot information transmission unit directly transmitting operation slot information about an operation slot of the communication node to a first access communication node; a receiving unit receiving first operation slot information about an operation slot selected by the first access communication node from the first access communication node based on the transmitted operation slot information; a selected slot control unit comparing the first operation slot information with second operation slot information about an operation slot selected by a second access communication node, the second access communication node being capable of directly receiving data from the communication node and incapable of directly receiving the data from the first access communication node; and a transmission unit transmitting a noncollision confirmation message to the first access communication node based on a result of the comparing.

According to an aspect of the present invention, there is provided a mesh network including a plurality of communication nodes, the mesh network including: a first access communication node and second access communication node connecting to the mesh network; and a communication node selecting a preferential access node from the first access communication node and second access communication node and transmits a noncollision confirmation message to the preferential access node, when an operation slot selected by the first access communication node and an operation slot selected by the second access communication node collide, wherein an access communication node receiving the noncollision confirmation message transmits data to the communication node during a duration of the selected operation slot according to the noncollision confirmation message.

According to an aspect of the present invention, there is provided a communication node included in a mesh network, the communication node including: a transmission unit transmitting first data to a second communication node capable of directly receiving data from the communication node during an operation slot duration of the communication node; and a receiving unit receiving second data from the second communication node during an operation slot duration of the second communication node.

### BRIEF DESCRIPTION OF THE DRAWINGS

FIG. 1 is a diagram illustrating a single beacon period divided into a plurality of operation slots according to an embodiment of the present invention;

FIG. 2 is a conceptual diagram illustrating selecting an operation slot which does not collide with an operation slot selected by a communication node adjacent to an access communication node connecting to a mesh network according to an embodiment of the present invention;

FIG. 3 is a conceptual diagram illustrating determining an operation slot of an access communication node connecting to a mesh network based on operation slot information of a communication node included in the mesh network according to an embodiment of the present invention;

FIG. 4 is a diagram illustrating a minimum number of operation slots to divide a single beacon period according to an embodiment of the present invention;

FIG. 5 is a graph illustrating a number of communication nodes where selected operation slots collide with each other from among communication nodes adjacent to a specific communication node according to an embodiment of the present invention;

FIG. 6 is a conceptual diagram illustrating that operation slots selected by a plurality of access communication nodes connecting to a mesh network collide with each other according to an embodiment of the present invention;

FIG. 7 is a block diagram illustrating a configuration of an access communication node connecting to a mesh network according to an embodiment of the present invention;

FIG. 8 is a block diagram illustrating a configuration of a communication node transmitting a noncollision confirmation message to any one of a plurality of access communication nodes connecting to a mesh network according to an embodiment of the present invention;

FIG. 9 is a diagram illustrating an operation where two access communication nodes selecting a same operation slot solves a collision of the operation slot according to an embodiment of the present invention;

FIG. 10 is a diagram illustrating an operation where a communication node transmits a noncollision confirmation message to any one of a plurality of access communication nodes connecting to a mesh network, when operation slots selected by the plurality of access communication nodes collide with each other according to an embodiment of the present invention;

FIG. 11 is a block diagram illustrating a configuration of a communication node transmitting data using a determined operation slot according to an embodiment of the present invention; and

FIG. 12 is a block diagram illustrating a configuration of a mesh network transmitting data using a determined operation slot according to an embodiment of the present invention.

### MODE FOR THE INVENTION

Hereinafter, embodiments of the present invention are described in detail by referring to the figures.

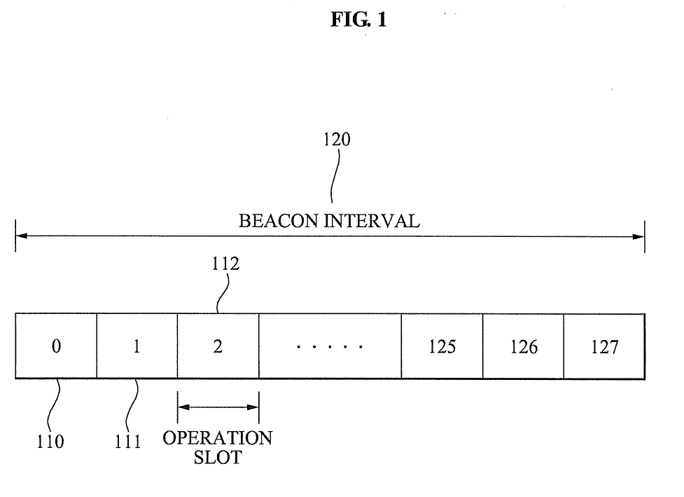

FIG. 1 is a diagram illustrating a single beacon period 120 divided into a plurality of operation slots according to an embodiment of the present invention. As illustrated in FIG. 1, the single beacon period 120 may be divided into the plurality of operation slots 110, 111, and 112. A mesh network according to an embodiment of the present invention transmits data based on a beacon period and operation slot.

According to an embodiment of the present invention, a communication node included in the mesh network may select at least one of the plurality of operation slots included in the beacon period 120. Also, the communication node may receive/transmit data during a of the selected operation slot duration.

According to an embodiment of the present invention, when a BO parameter and SO parameter of a Zigbee network layer standard are ‘seven’ and ‘one’, respectively, a beacon period is determined to be approximately ‘two’ seconds and each operation slot duration is determined to be ‘15’ ms. In this case, a single beacon period includes 128 operation slots.

In the present specification, ‘communication node’ refers to a node which is included in a mesh network and transmits data, and ‘access communication node’ refers to a node which selects an operation slot in order to connect to the mesh network. When the access communication node connecting to the mesh network selects an operation slot which does not collide with an operation slot of the communication node included in the mesh network, the access communication node becomes a new communication node included in the mesh network, and may transmit data to another existing communication node during the selected operation slot duration.

According to an embodiment of the present invention, the communication node included in the mesh network may select at least one operation time duration in a single beacon period. The communication node may receive/transmit the data from/to an adjacent communication node during the selected operation time duration, and may not receive/transmit the data during another operation time duration.

According to an embodiment of the present invention, the communication node included in the mesh network transmits the data using extremely low power to be operated for a long time. A data transmission distance is limited due to a limitation of transmission power. Accordingly, the data may not be directly transmitted to all communication nodes included in the mesh network, and the data is transmitted to an adjacent communication node. A communication node receiving the data from a communication node transmitting the data forwards the data to the adjacent communication node again. The data may be transmitted to a final destination communication node via the plurality of communication nodes included in the mesh network.

In the present specification, ‘data may be directly transmitted among communication nodes’ indicates a communication node receiving data is located within a maximum data transmission distance of a communication node transmitting data. Also, it indicates the communication node receiving data may receive an electric wave, infrared rays, and the like transmitted from the communication node transmitting data, since a communication between the communication node receiving data and the communication node transmitting data is not interrupted.

In the present specification, ‘one-hop distance’ refers to a distance where data may be directly received from a communication node transmitting data. Accordingly, the one-hop distance is determined considering propagation characteristics of a wireless link between the communication node transmitting data and communication node receiving data as well as a maximum transmission power of the communication node transmitting data. That is, the one-hoop distance is different from a maximum data transmission distance determined considering only the maximum transmission power of the communication node transmitting data. Specifically, a communication node, which receives data and is located within the maximum data transmission distance of the communication node transmitting data, may not be a communication node which receives data and is located within the one-hop distance.

For example, when a communication node receiving data may directly receive the data from a communication node transmitting data, the communication node transmitting data may be considered to be located within a one-hop distance from the communication node receiving data. That is, the communication node transmitting data and the communication node receiving data may be defined as one-hop neighboring communication nodes.

Also, in the present specification, ‘data may not be directly transmitted among communication nodes’ indicates a communication node receiving data is not located within a maximum data transmission distance of a communication node transmitting data. Also, it indicates the communication node receiving data may not receive an electric wave, infrared rays, and the like transmitted from the communication node transmitting data due to interference, although the communication node receiving data is located within the maximum data transmission distance.

When the data may not be directly transmitted among communication nodes, the communication node transmitting data may directly transmit the data to a communication node forwarding data. The communication node forwarding data may directly receive the data from the communication node transmitting data, and directly transmit the received data to the communication node receiving data, which is referred to as ‘data is indirectly transmitted among communication nodes’. Several communication nodes forwarding data may be used to transmit particular data.

For example, when a single communication node forwarding data is used from a communication node transmitting data to a communication node receiving data, the communication node transmitting data is located within a two-hop distance from the communication node receiving data. Also, the communication node transmitting data and the communication node receiving data may be defined as a ‘two-hop neighboring communication node’. When the data is indirectly transmitted using n-1 communication nodes forwarding data, the communication node transmitting data is located within an n-hop distance from the communication node receiving data. Also, the communication node transmitting data and the communication node receiving data may be defined as ‘n-hop neighboring communication node’.

The access communication node connecting to the mesh network searches neighboring communication nodes. According to an embodiment of the present invention, the access communication node scans available frequencies for a sufficient time, and thereby may ascertain whether a communication node connecting to the mesh network exists.

The access communication node selects a suitable communication node from the searched communication nodes as a parent node. According to an embodiment of the present invention, the access communication node may select a communication node which receives a strongest signal from the communication node as the parent node.

The access communication node is synchronized with the parent node based on a signal received from the parent node. According to an embodiment of the present invention, the communication node selected as the parent node periodically transmits a beacon signal, and the access communication node may be synchronized with the parent node using the beacon signal.

The access communication node transmits an association request message to the selected parent node, and the parent node transmits an association response message to the access communication node. The association response message includes a parameter describing a network feature, a network address value assigned to the access communication node, and the like.

The access communication node selects an operation slot which does not collide with an operation slot of a one-hop neighboring communication node and two-hop neighboring communication node ascertained during a neighboring node search operation, and transmit the data to the communication node.

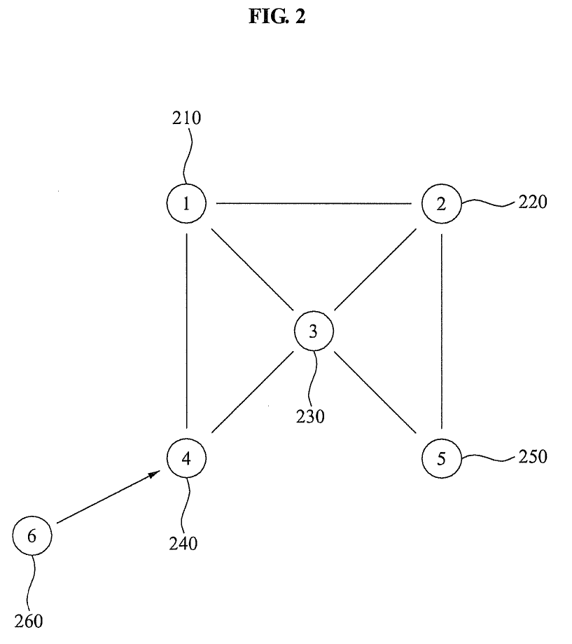

FIG. 2 is a conceptual diagram illustrating selecting an operation slot which does not collide with an operation slot selected by a communication node adjacent to an access communication node connecting to a mesh network according to an embodiment of the present invention. In FIG. 2, a 1^{st} communication node 210, 2^{nd} communication node 220, 3^{rd} communication node 230, 4^{th} communication node 240, and 5^{th} communication node 250 are included in the mesh network.

An access communication node 260 connects to the mesh network. Each of the 1^{st} communication node 210, 2^{nd} communication node 220, 3^{rd} communication node 230, 4^{th} communication node 240, and 5^{th} communication node 250 previously determines an operation slot of each of the 1^{st} communication node 210, 2^{nd} communication node 220, 3^{rd} communication node 230, 4^{th} communication node 240, and 5^{th} communication node 250. Also, each of the 1^{st} communication node 210, 2^{nd} communication node 220, 3^{rd} communication node 230, 4^{th} communication node 240, and 5^{th} communication node 250 receives/transmits data during a duration of the determined operation slot. However, the access communication node 260 connecting to the mesh network is required to transmit the data during an operation slot duration of the selected operation slot after selecting a specific operation slot and confirming whether the selected operation slot collides with an operation slot of an existing communication node included in the mesh network.

When the access communication node 260 selects an operation slot colliding with an operation slot of the 4^{th} communication node 240, the access communication node 260 may transmit the data to the 4^{th} communication node 240 while the 4^{th} communication node 240 transmits the data to the 1^{st} communication node 210 or 3^{rd} communication node 230. In this instance, since the 4^{th} communication node 240 may not receive the data, the access communication node 260 is required to select an operation slot which does not collide with the operation slot of the 4^{th} communication node 240 which is a one-hop neighboring communication node of the access communication node in order to connect to the mesh network and receive/transmit the data.

Also, the access communication node 260 is required to consider an operation slot of a two-hop neighboring communication node, that is, the 1^{st} communication node 210 and 3^{rd} communication node 230. When the access communication node selects an operation slot colliding with an operation slot of the 3^{rd} communication node 230, the access communication node 260 and 3^{rd} communication node 230 transmit the data to the 4^{th} communication node 240 during a same operation slot duration. The data transmitted from the access communication node 260 and the data transmitted from the 3^{rd} communication node 230 collide with each other, and thus the 4^{th} communication node 240 may not receive any data.

Accordingly, the access communication node 260 is required to select an operation slot considering operation slot information of one-hop neighboring communication node and two-hop neighboring communication node.

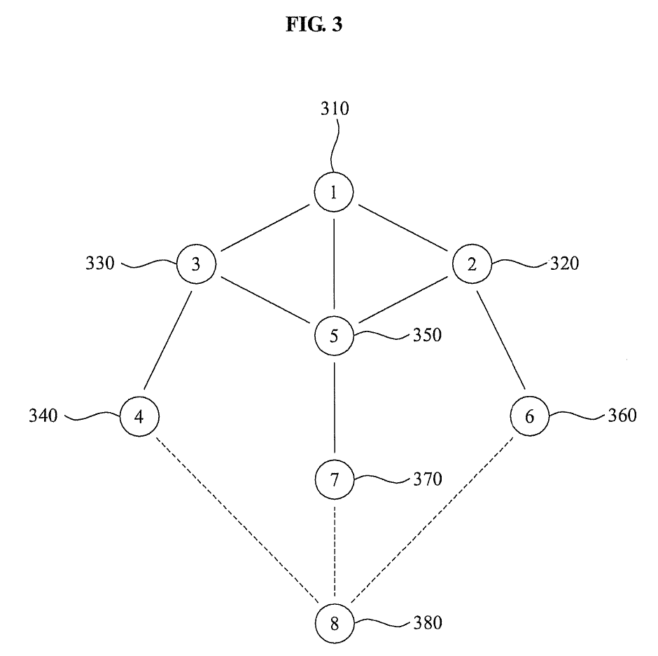

FIG. 3 is a conceptual diagram illustrating determining an operation slot of an access communication node connecting to a mesh network based on operation slot information of a communication node included in the mesh network according to an embodiment of the present invention.

In FIG. 3, a 1^{st} communication node 310, 2^{nd} communication node 320, 3^{rd} communication node 330, 4^{th} communication node 340, 5^{th} communication node 350, 6^{th} communication node 360, and 7^{th} communication node 370 are included in the mesh network. The 4^{th} communication node 340, 6^{th} communication node 360, and 7^{th} communication node 370 are a three-hop neighboring communication node to each other. Even when transmitting data during an operation slot duration of operation slots colliding with each other, the 4^{th} communication node 340, 6^{th} communication node 360, and 7^{th} communication node 370 may select a same operation slot since the transmitted data does not collide.

However, when an access communication node 380 connects to the mesh network, the 4^{th} communication node 340, 6^{th} communication node 360, and 7^{th} communication node 370 become a two-hop neighboring communication node to each other due to the access communication node 380. Accordingly, the 4^{th} communication node 340, 6^{th} communication node 360, and 7^{th} communication node 370 may not transmit the data during the operation slot duration of the operation slots colliding with each other.

Accordingly, to prevent the above-described situation, an operation slot of at least three-hop neighboring communication node is required to be determined not to collide with each other. However, collecting operation slot information of the at least three-hop neighboring communication node is inefficient. Also, since a possibility of colliding operation slots of the at least three-hop neighboring communication node is extremely low, it is efficient to determine an operation slot of the access communication node based on operation slot information of a one-hop neighboring communication node or two-hop neighboring communication node.

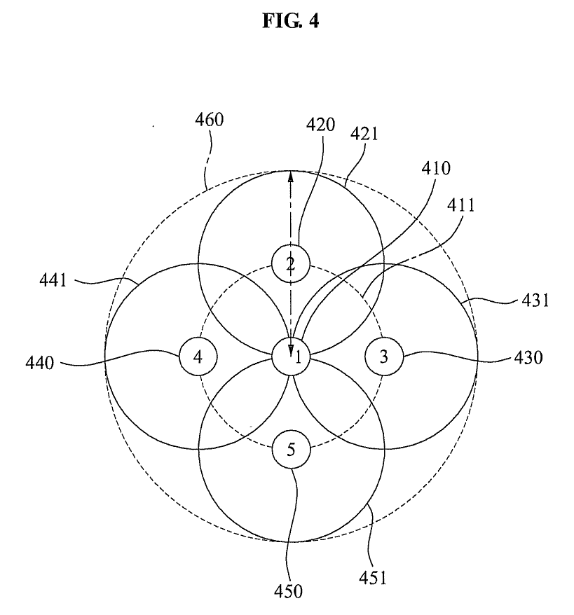

FIG. 4 is a diagram illustrating a minimum number of operation slots to divide a single beacon period according to an embodiment of the present invention.

A 2^{nd} communication node 420, 3^{rd} communication node 430, 4^{th} communication node 440, and 5^{th} communication node 450 are located around a 1^{st} communication node 410. The 2^{nd} communication node 420, 3^{rd} communication node 430, 4^{th} communication node 440, and 5^{th} communication node 450 may directly receive data from the 1^{st} communication node 410. The 2^{nd} communication node 420, 3^{rd} communication node 430, 4^{th} communication node 440, and 5^{th} communication node 450 are located within a circle whose radius is a one-hop distance and center is the 1^{st} communication node 410.

When a two-hop distance circle 460 having a radius which is twice as the one-hop distance from the 1^{st} communication node 410 is assumed, an area of the two-hop distance circle 460 is four times as large as a one-hop distance circle 411. Accordingly, when k one-hop neighboring communication nodes exist in the one-hop distance circle 411, a number of one-hop neighboring communication node or two-hop neighboring communication node in the tow-hop distance circle 460 is 4 k.

At least one operation slot is required for an access communication node connecting to a mesh network and the 4 k one-hop neighboring communication nodes or 4 k two-hop neighboring communication nodes around the access communication node. Accordingly, a number of operation slots included in a single beacon period is required to be 4 k+1 so that the access communication node normally selects an operation slot and transmits data during an operation slot duration of the selected operation slot.

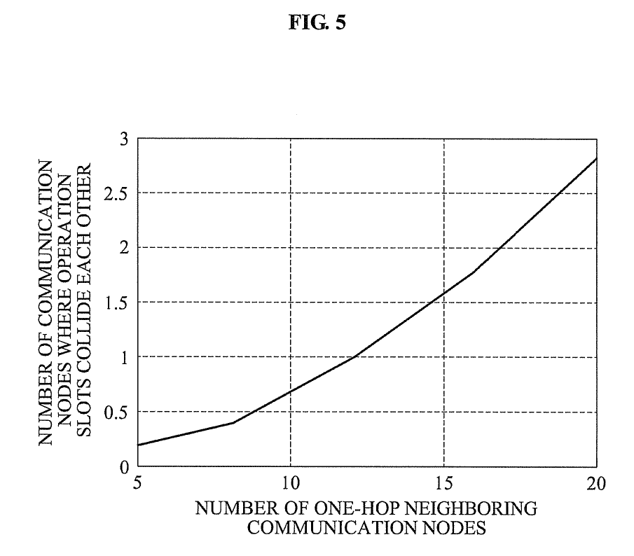

FIG. 5 is a graph illustrating a number of communication nodes where selected operation slots collide with each other from among communication nodes adjacent to a specific communication node according to an embodiment of the present invention.

It is assumed that k one-hop neighboring communication nodes exist around an access communication node connecting to a mesh network. Also, it is assumed that all the k one-hop neighboring communication nodes are at least three-hop neighboring communication nodes before the access communication node connects to the mesh network, and it is assumed that each operation slot is not determined based on operation slot information of other communication nodes.

An operation slot of each of the k one-hop neighboring communication nodes may be considered to be determined independently, which may be modeled as an occupancy problem. Accordingly, an expected number of communication nodes where operation slots collide with each other from among the k one-hop neighboring communication nodes may be represented as,

E=k−e^{-γ}·s·(1−e^{-λ}) [Equation 1]

Here, s denotes a number of operation slots configuring a single beacon period. In an embodiment of FIG. 1, s is equals 128. Also, λ is given by,

$$λ = \frac{k}{s} \qquad [ Equation 2 ]$$

Also, γ is given by,

$$γ = \frac{k - a}{a} \qquad [ Equation 3 ]$$

Here, a denotes an average of a number of operation slots occupied by the k one-hop neighboring communication nodes from among the s operation slots. A is given by,

a=s·(1−e^{-λ}) [Equation 4]

FIG. 5 illustrates the expected number of communication nodes where the operation slots collide with each other from among the k one-hop neighboring communication nodes, when the single beacon period is divided into 128 operation slots. In this case, s is 128. A horizontal axis indicates a number of one-hop neighboring communication nodes of the access communication node. A vertical axis indicates a number of communication nodes where the operation slots collide with each other from among the k one-hop neighboring communication nodes. According to a graph in FIG. 5, when the access communication node includes 20 one-hop neighboring communication nodes, on average, three or fewer one-hop neighboring communication nodes where operation slots are duplicated exist, and 17 one-hop neighboring communication nodes where operation slots are not duplicated exist. The average value does not significantly affect network configuration.

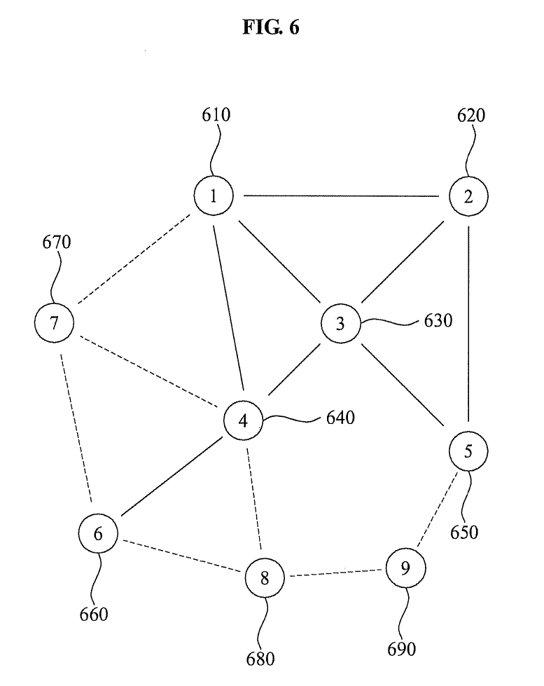

FIG. 6 is a conceptual diagram illustrating that operation slots selected by a plurality of access communication nodes connecting to a mesh network collide with each other according to an embodiment of the present invention.

In FIG. 6, the mesh network includes six communication nodes 610, 620, 630, 640, 650, and 660. A 1^{st} access communication node 670, 2^{nd} access communication node 680, and 3^{rd} access communication node 690 select an operation slot to connect to the mesh network. The 1^{st} access communication node 670 selects an operation of the 1^{st} access communication node 670 based on operation slot information of one-hop neighboring communication nodes or two-hop neighboring communication nodes from the 1^{st} access communication node 670, from among the six communication nodes 610, 620, 630, 640, 650, and 660. The six communication nodes 610, 620, 630, 640, 650, and 660 are already connected to the mesh network, and are transmitting data. Also, the 2^{nd} access communication node 680 and 3^{rd} access communication node 690 may select an operation slot of each of the 2^{nd} access communication node 680 and 3^{rd} access communication node 690 based on operation slot information of one-hop neighboring communication nodes or two-hop neighboring communication nodes from the 2^{nd} access communication node 680 and 3^{rd} access communication node 690.

When the 1^{st} access communication node 670, 2^{nd} access communication node 680, and 3^{rd} access communication node 690 select an operation slot, the 1^{st} access communication node 670 may not collect information about an operation slot selected by the 2^{nd} or 3^{rd} access communication nodes 680 or 690, the 2^{nd} access communication node 680 may not collect information about an operation slot selected by the 1^{st} or 3^{rd} access communication node 670 or 690, and the 3^{rd} access communication node 690 may not collect information about an operation slot selected by the 1^{st} or 2^{nd} access communication node 670 or 680. Accordingly, operation slots selected by each of the 1^{st} access communication node 670, 2^{nd} access communication node 680, and 3^{rd} access communication node 690 may collide.

The 2^{nd} access communication node 680 is required to select an operation slot based on operation slot information of a communication node which is already connected to the mesh network and transmits the data. Also, the 2^{nd} access communication node 680 is required to determine whether the selected operation slot collides with the other access communication nodes 670 and 690 which try to connect to the mesh network.

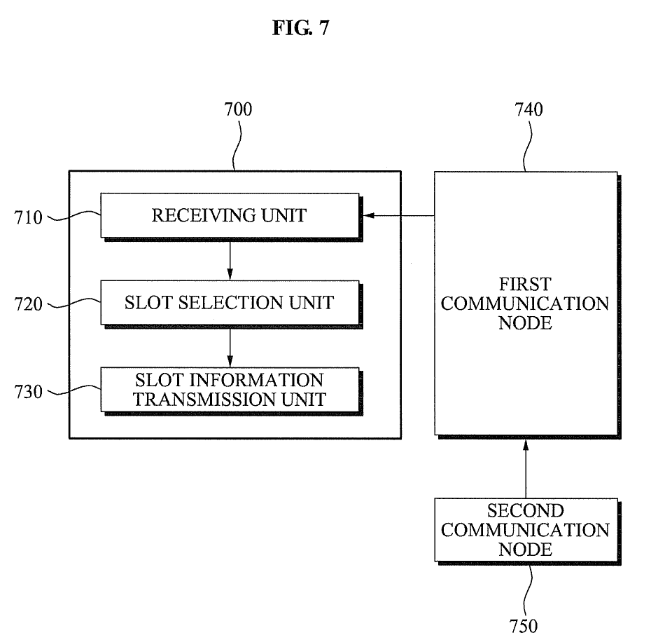

FIG. 7 is a block diagram illustrating a configuration of an access communication node 700 connecting to a mesh network according to an embodiment of the present invention. Hereinafter, the configuration of the access communication node 700 is described in detail with reference to FIG. 7. The access communication node 700 includes a receiving unit 710, slot selection unit 720, and slot information transmission unit 730.

The receiving unit 710 receives first operation slot information of a 1^{st} communication node 740 from the 1^{st} communication node 740 and second operation slot information of a 2^{nd} communication node 750 from the 1^{st} communication node 740. The 1^{st} communication node 740 is capable of directly transmitting data to the access communication node 700. The 2^{nd} communication node 750 is capable of directly transmitting data to the 1^{st} communication node 740 and incapable of directly transmitting data to the access communication node 700. The 1^{st} communication node 740 is a one-hop neighboring communication node from the access communication node 700, and may directly transmit the data to the access communication node 700. The 2^{nd} communication node 750 is a two-hop neighboring communication node from the access communication node 700, and transmits operation slot information to the access communication node 700 via the 1^{st} communication node 740.

According to an embodiment of the present invention, the receiving unit 710 may receive a beacon signal including the first operation slot information and second operation slot information from the 1^{st} communication node 740.

The slot selection unit 720 selects an operation slot of the access communication node 700 based on the first operation slot information and second operation slot information. According to an embodiment of the present invention, the slot selection unit 720 may select an operation slot which does not collide with a first operation slot of the 1^{st} communication node 740 and a second operation slot of the 2^{nd} communication node 750 from among a plurality of operation slots configuring a beacon period.

According to an embodiment of the present invention, when external noise exists or a 2^{nd} access communication node which tries to simultaneously connect to the mesh network together with the access communication node 700 exists, the beacon signal may not be received from the 1^{st} communication node 740. Since the first operation slot information or second operation slot information may not be received from the 1^{st} communication node 740, the operation slot selected by the access communication node may collide with the operation slot selected by the 1^{st} communication node 740 or 2^{nd} communication node 750. When it is determined that the operation slots collide with each other, the slot selection unit 720 may cancel the selected operation slot, and reselect a new operation slot.

According to an embodiment of the present invention, when the receiving unit 710 receives the beacon signal from the 1^{st} communication node 740 during a duration of the operation slot selected by the slot selection unit 720, the selected operation slot may be determined to collide with the first operation slot of the 1^{st} communication node 740.

When the receiving unit 710 does not receive the beacon signal from the 1^{st} communication node 740, the slot selection unit 720 determines that the selected operation slot does not collide with the first operation slot of the 1^{st} communication node 740, and the slot information transmission unit 730 may transmit operation slot information of the selected operation slot to the 1^{st} communication node 740. According to an embodiment of the present invention, the slot information transmission unit 730 may transmit the beacon signal including the operation slot information of the selected operation slot. Since an operation slot is repeated at every beacon period, the slot information transmission unit 730 may repeatedly and periodically transmit the operation slot information of the selected operation slot.

According to an embodiment of the present invention, the slot information transmission unit 730 may transmit the operation slot information of the selected operation slot using a tree routing defined based on a Zigbee standard.

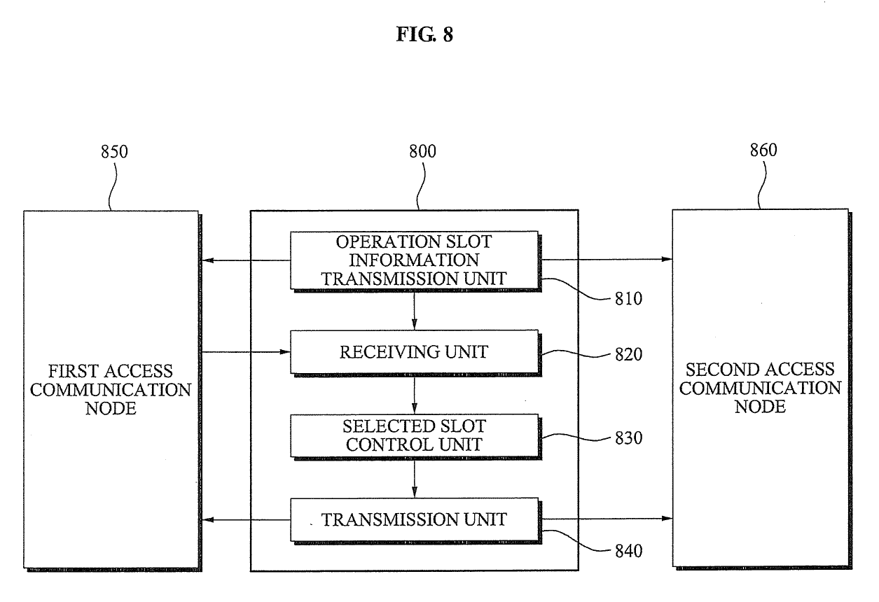

FIG. 8 is a block diagram illustrating a configuration of a communication node 800 transmitting a noncollision confirmation message to any one of a plurality of access communication nodes connecting to a mesh network according to an embodiment of the present invention. Hereinafter, an operation of the communication node 800 is described in detail with reference to FIG. 8. The communication node 800 includes an operation slot information transmission unit 810, receiving unit 820, selection slot control unit 830, and transmission unit 840.

The operation slot information transmission unit 810 directly transmits operation slot information about an operation slot of the communication node 800 to a 1^{st} access communication node 850. The 1^{st} access communication node 850 is located within a one-hop distance from the communication node 800. According to an embodiment of the present invention, the operation slot information transmission unit 810 may transmit operation slot information of the operation slot information transmission unit 810 as well as second operation slot information about an operation slot of a 2^{nd} communication node. The 2^{nd} communication node is located within the one-hop distance from the communication node 800.

The receiving unit 820 receives first operation slot information from the 1^{st} access communication node 850 based on the operation slot information transmitted from the operation slot information transmission unit 810. The first operation slot information is about an operation slot selected by the 1^{st} access communication node 850. According to an embodiment of the present invention, the 1^{st} access communication node 850 may select an operation slot based on the second operation slot information about an operation slot of the 2^{nd} communication node located within the one-hop distance from the communication node 800.

According to an embodiment of the present invention, the receiving unit 820 may receive the first operation slot information from the 1^{st} access communication node 850 during an operation slot duration of the communication node 800.

According to another embodiment of the present invention, the receiving unit 820 may receive the first operation slot information using a tree routing defined based on the Zigbee standard.

The selection slot control unit 830 compares the first operation slot information with second operation slot information about an operation slot selected by a 2^{nd} access communication node. The 2^{nd} access communication node is capable of directly receiving data from the communication node 800 and incapable of directly receiving the data from the 1^{st} access communication node 850. That is, the 1^{st} access communication node 850 and 2^{nd} access communication node 860 are a two-hop neighboring access communication node to each other. The two-hop neighboring access communication nodes may not directly exchange information about an operation slot Accordingly, the communication node 800 located between the 1^{st} access communication node 850 and 2^{nd} access communication node 860 compares the information about the operation slots selected by the 1^{st} access communication node 850 and 2^{nd} access communication node 860, and instructs any one of the 1^{st} access communication node 850 and 2^{nd} access communication node 860 to reselect an operation slot.

The transmission unit 840 may transmit a noncollision confirmation message to the 1^{st} access communication node 850 based on a result of the comparing. The noncollision confirmation message is generated by the selection slot control unit 830.

According to an embodiment of the present invention, when the operation slot selected by the 1^{st} access communication node 850 and the operation slot selected by the 2^{nd} access communication node 860 do not collide, the selection slot control unit 830 may generate the noncollision confirmation message to be transmitted to each of the 1^{st} access communication node 850 and the 2^{nd} access communication node 860.

According to an embodiment of the present invention, when the operation slot selected by the 1^{st} access communication node 850 and the operation slot selected by the 2^{nd} access communication node 860 collide, the selection slot control unit 830 may select a preferential access node from among the 1^{st} access communication node 850 and the 2^{nd} access communication node 860. The preferential access node is a node to be preferentially connected to a mesh network. According to an embodiment of the present invention, the selection slot control unit 830 may generate the noncollision confirmation message to be transmitted to the preferential access node, and the transmission unit 840 may transmit the generated noncollision confirmation message to the preferential access node.

The 1^{st} access communication node 850 receiving the noncollision confirmation message determines that a first operation slot selected by the 1^{st} access communication node 850 does not collide with a second operation slot selected by the 2^{nd} access communication node 860. Also, the 1^{st} access communication node 850 may receive/transmit the data from/to the communication node 800 during a first operation slot duration.

The 2^{nd} access communication node 860 which does not receive the noncollision confirmation message determines that the first operation slot collides with the second operation slot. Also, the 2^{nd} access communication node 860 may cancel the selected second operation slot and reselect a new operation slot.

According to an embodiment of the present invention, the receiving unit 820 receives an assigned network address value from the 1^{st} access communication node 850 and the 2^{nd} access communication node 860. The selection slot control unit 830 may select the preferential access node based on the network address value assigned to each of the 1^{st} access communication node 850 and the 2^{nd} access communication node 860. According to an embodiment of the present invention, an access communication node having a higher network address value may be selected as the preferential access node.

According to an embodiment of the present invention, the transmission unit 840 may transmit a collision confirmation message to the 2^{nd} access communication node 860 which is not selected as the preferential access node based on a result of the comparing. When the operation slot selected by the 1^{st} access communication node 850 and the operation slot selected by the 2^{nd} access communication node 860 collide, the transmission unit 840 may transmit the collision confirmation message to the 2^{nd} access communication node 860 which is not selected as the preferential access node. The collision confirmation message indicates to cancel the selected operation slot and reselect a new operation slot since an operation slot selected by an access communication node collides with an operation slot selected by another access communication node. The 2^{nd} access communication node 860 receiving the collision confirmation message determines that the operation slot selected by the 1^{st} access communication node 850 and the operation slot selected by the 2^{nd} access communication node 860 are identical and collide with each other. Also, the 2^{nd} access communication node 860 may cancel the selected operation slot and reselect a new operation slot.

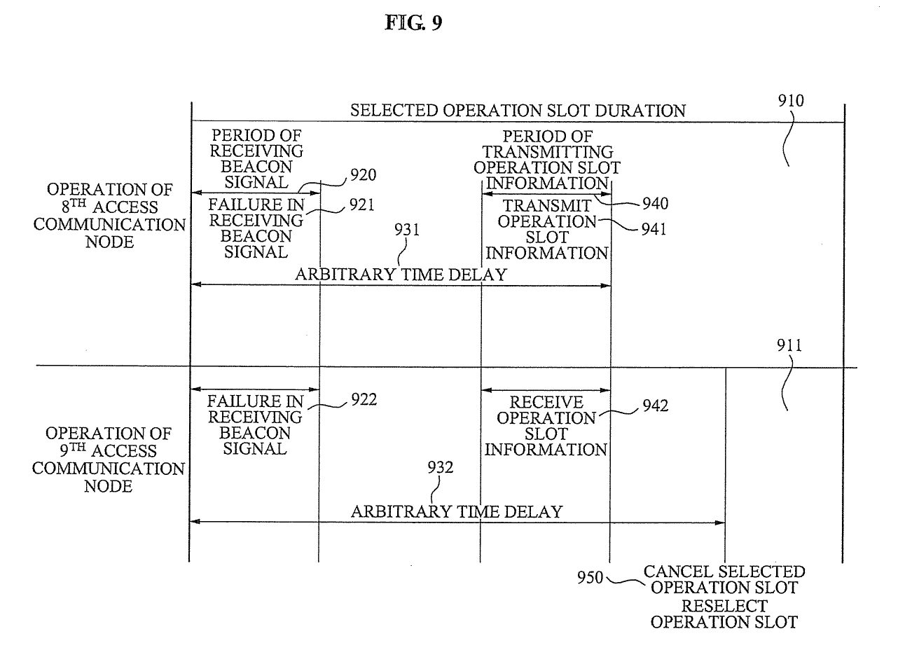

FIG. 9 is a diagram illustrating an operation where two access communication nodes selecting a same operation slot solves a collision of the operation slot according to an embodiment of the present invention. An 8^{th} access communication node and 9^{th} access communication node are one-hop neighboring access communication nodes located within one-hop distance to each other. That is, the 8^{th} access communication node and 9^{th} access communication node are access communication nodes which may directly transmit data. According to an embodiment of the present invention, the 8^{th} access communication node and 9^{th} access communication node transmit information about a selected operation slot to the one-hop neighboring access communication node, that is, the 8^{th} access communication node or 9^{th} access communication node. Operation slot information about the one-hop neighboring access communication node, that is, the 8^{th} access communication node and 9^{th} access communication node, is received. Also, whether the operation slots collide with each other is confirmed. According to an embodiment of the present invention, when the operation slots collide, a selected operation slot may be canceled, and a new operation slot may be reselected.

The 8^{th} access communication node receives a beacon signal from one-hop neighboring communication nodes during a duration 920 of receiving the beacon signal of a duration of the selected operation slot. When the beacon signal is successfully received, it is determined that an operation slot of the one-hop neighboring communication nodes collides with the selected operation slot. When the operation slot of the one-hop neighboring communication nodes collides with the selected operation slot, the selected operation slot is canceled and a new operation slot is reselected.

When the beacon signal may not be received in operation 921 and operation 922, the 8^{th} access communication node may determine that the operation slot selected by the 8^{th} access communication node does not collide with the operation slot of the one-hop neighboring communication nodes. The one-hop neighboring communication nodes are located within the one-hop distance from the 8^{th} access communication node. However, the 9^{th} access communication node may select an operation slot same as the operation slot selected by the 8^{th} access communication node, and thus the 8^{th} access communication node may not receive or transmit the data during the duration of the selected operation slot. The 9^{th} access communication node is located within the one-hop distance from the 8^{th} access communication node.

In FIG. 9, it is illustrated that each of the 8^{th} access communication node and 9^{th} access communication node may not receive the beacon signal from the one-hop neighboring communication node.

A receiving unit 710 of the 8^{th} access communication node waits to receive operation slot information from the 9^{th} access communication node during an arbitrary time delay 931 from a starting point of the duration of the selected operation slot. The 9^{th} access communication node is located within the one-hop distance from the 8^{th} access communication node. When the 8^{th} access communication node does not receive operation slot information of the 9^{th} access communication node during the arbitrary time delay 931, a slot information transmission unit 730 may transmit the operation slot information about the selected operation slot to the 9^{th} access communication node in operation 941.

In FIG. 9, it is illustrated that an arbitrary time delay 932 set by the 9^{th} access communication node is longer than the arbitrary time delay 931 set by the 8^{th} access communication node.

The 8^{th} access communication node transmitting the operation slot information in operation 941 may determine that the selected operation slot of the 8^{th} access communication node does not collide with the operation slot of the one-hop neighboring access communication node

When a receiving unit 710 of the 9^{th} access communication node receives the operation slot information of the 8^{th} access communication node during the arbitrary time delay 932 in operation 942, a slot selection unit 720 may determine that the selected operation slot collides with an operation slot selected by the one-hop neighboring access communication node.

The 9^{th} access communication node receives the operation slot information from the 8^{th} access communication node during the arbitrary time delay 932 in operation 942, and thus the 9^{th} access communication node may cancel the selected operation slot and reselect a new operation slot.

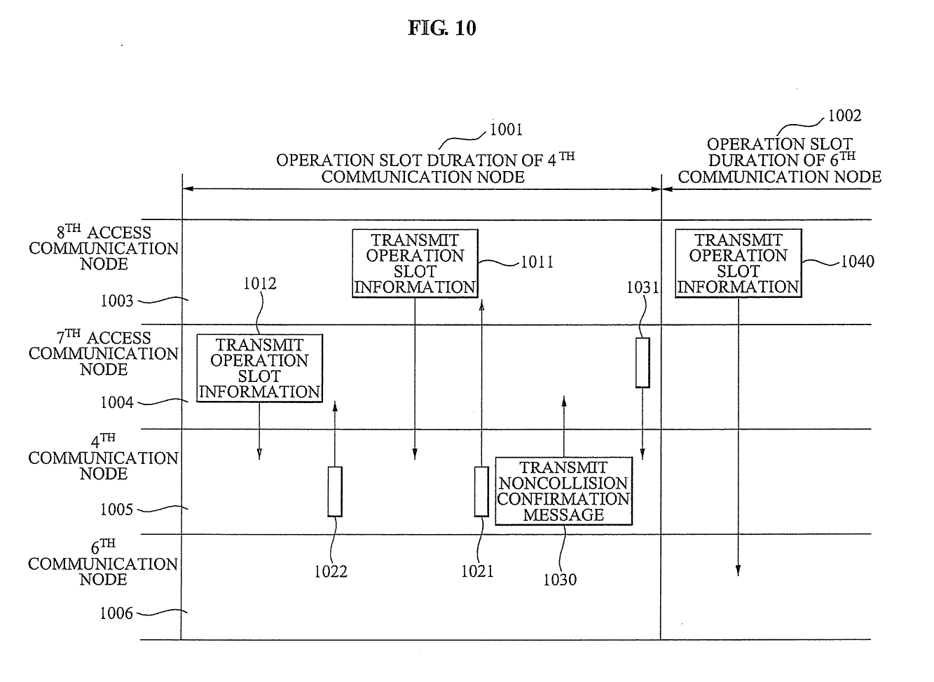

FIG. 10 is a diagram illustrating an operation where a communication node transmits a noncollision confirmation message to any one of a plurality of access communication nodes connecting to a mesh network, when operation slots selected by the plurality of access communication nodes collide with each other according to an embodiment of the present invention.

A 7^{th} access communication node and 8^{th} access communication node are two-hop neighboring access communication nodes to each other. An operation slot collision when the 7^{th} access communication node and 8^{th} access communication node select a same operation slot may not be solved by a method described in FIG. 9. The method solves a collision when operation slots selected by one-hop neighboring access communication nodes collide with each other.

Each of the 7^{th} access communication node and 8^{th} access communication node transmits operation slot information about an operation slot of each of the 7^{th} access communication node and 8^{th} access communication node to one-hop neighboring communication nodes, when one-hop neighboring access communication nodes do not exist or when a selected operation slot does not collide with an operation slot selected by the one-hop neighboring access communication node.

From among the one-hop neighboring communication nodes based on each of the 7^{th} access communication node and 8^{th} access communication node, the 4^{th} communication node and 6^{th} communication node are located within a one-hop distance from the 7^{th} access communication node and 8^{th} access communication node. Accordingly, the 4^{th} communication node and 6^{th} communication node receive operation slot information transmitted by the each of the 7^{th} access communication node and 8^{th} access communication node. That is, when each of the 7^{th} access communication node and 8^{th} access communication node transmits data during a same operation slot duration, the transmitted data collides, and thus the 4^{th} communication node and 6^{th} communication node may not successfully receive the data from the 7^{th} access communication node and 8^{th} access communication node.

A slot information transmission unit 730 of each of the 7^{th} access communication node and 8^{th} access communication node may transmit operation slot information about a selected operation slot to the 4^{th} communication node in operation 1011 and operation 1012.

According to an embodiment of the present invention, the slot information transmission unit 730 of each of the 7^{th} access communication node and 8^{th} access communication node may transmit the operation slot information about the operation slot selected by each of the 7^{th} access communication node and 8^{th} access communication node to the 4^{th} communication node during an operation slot duration 1001 of the 4^{th} communication node.

According to another embodiment of the present invention, the slot information transmission unit 730 of each of the 7^{th} access communication node and 8^{th} access communication node may transmit the operation slot information about the operation slot selected by each of the 7^{th} access communication node and 8^{th} access communication node to the 4^{th} communication node using a tree routing defined based on a Zigbee standard.

According to an embodiment of the present invention, the 4^{th} communication node may receive the operation slot information from each of the 7^{th} access communication node and 8^{th} access communication node, and transmit an operation slot confirmation message to each of the 7^{th} access communication node and 8^{th} access communication node in operation 1021 and operation 1022.

According to an embodiment of the present invention, the 4^{th} communication node compares the received operation slot information. When the operation slot information selected by each of the 7^{th} access communication node and 8^{th} access communication node is identical, the 4^{th} communication node may select any one of the 7^{th} access communication node and 8^{th} access communication node as a preferential access node.

In FIG. 10, it is illustrated that the 4^{th} communication node selects the 7^{th} access communication node as the preferential access node. The 4^{th} communication node may transmit a noncollision confirmation message to the 7^{th} access communication node selected as the preferential access node in operation 1030. The 7^{th} access communication node receiving the noncollision confirmation message may transmit a receipt confirmation message to the 4^{th} communication node in operation 1031.

According to an embodiment of the present invention, a receiving unit 710 of the 7^{th} access communication node receives the noncollision confirmation message from the 4^{th} communication node in response to the transmitted operation slot information. The noncollision confirmation message indicates that the operation slot selected by the 7^{th} access communication node does not collide with the operation slot selected by the 8^{th} access communication node. A slot selection unit 720 of the 7^{th} access communication node may determine the selected operation slot as an operation slot of the access communication node according to the noncollision confirmation message. The 7^{th} access communication node may receive/transmit the data during a duration of the determined operation slot.

According to an embodiment of the present invention, when a receiving unit 710 of the 8^{th} access communication node may not receive a noncollision confirmation message from the 4^{th} communication node, the slot selection unit 720 may cancel the selected operation slot and reselect a new operation slot. The noncollision confirmation message indicates that an operation slot of the 8^{th} access communication node does not collide with an operation slot of the 7^{th} access communication node.

According to an embodiment of the present invention, the 8^{th} access communication node may reselect the new operation slot and transmit operation slot information to the 6^{th} communication node in operation 1040. The 6^{th} communication node is located within the one-hop distance from the 8^{th} access communication node. According to an embodiment of the present invention, the 8^{th} access communication node may transmit operation slot information to the 6^{th} communication node during an operation slot duration 1002 of the 6^{th} communication node.

In FIG. 10, it is illustrated that the 7^{th} access communication node and 8^{th} access communication node select a same operation slot and connect to a mesh network. However, according to another embodiment of the present invention, at least three access communication nodes may select a same operation slot and connect to the mesh network. In this case, the 4^{th} communication node may select a preferential access node from the at least three access communication nodes, and transmit the noncollision confirmation message to the selected preferential access node.

According to an embodiment of the present invention, a transmission unit 840 of the 4^{th} communication node may transmit a collision confirmation message to the 8^{th} access communication node which is not selected as the preferential access node. The collision confirmation message indicates that the operation slot selected by the 7^{th} access communication node collides with the operation slot selected by the 8^{th} access communication node. The 8^{th} access communication node receiving the collision confirmation message may cancel the selected operation slot and reselect a new operation slot.

According to another embodiment of the present invention, when the at least three access communication nodes select a same slot and connect to the mesh network, the transmission unit 840 of the 4^{th} communication node may transmit the collision confirmation message to all nodes which are not selected as the preferential access node.

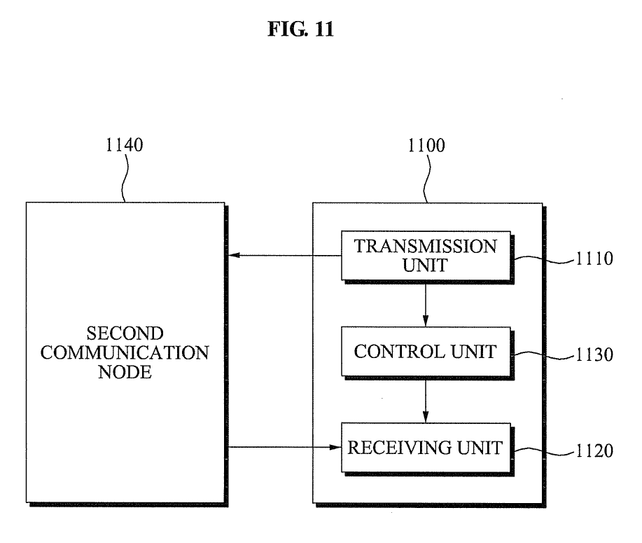

FIG. 11 is a block diagram illustrating a configuration of a communication node 1100 transmitting data using a determined operation slot according to an embodiment of the present invention. Hereinafter, the configuration of the communication node 1100 transmitting the data is described in detail with reference to FIG. 11. The communication node 1100 includes a transmission unit 1110, receiving unit 1120, and control unit 1130.

The transmission unit 1110 transmits first data to a 2^{nd} communication node 1140 during an operation slot duration. The 2^{nd} communication node 1140 is located within a one-hop distance from the communication node 1100. A strength of output signal is limited to reduce power consumption of the communication node 1100, and thus only the 2^{nd} communication node, which is located within the one-hop distance, may receive a signal from the communication node 1100.

According to an embodiment of the present invention, the transmission unit 1110 may transmit the first data to the 2^{nd} communication node 1140 during an operation slot duration of the 2^{nd} communication node 1140.

The receiving unit 1120 receives second data from the 2^{nd} communication node 1140 during the operation slot duration of the 2^{nd} communication node 1140. According to an embodiment of the present invention, the receiving unit 1120 may receive the second data from the 2^{nd} communication node 1140 during an operation slot duration of the communication node 1100.

The control unit 1130 may deactivate the transmission unit 1110 and receiving unit 1120 during an operation slot duration excluding the operation slot duration of the communication node 1100 or the operation slot duration of the 2^{nd} communication node 1140. Specifically, the transmission unit 1110 and receiving unit 1120 are deactivated during an operation slot duration when the communication node 110 does not transmit the data, power supply is cut, and thus the communication node 1100 may be operated for a longer time with a regular power.

According to an embodiment of the present invention, the 2^{nd} communication node 1140 may transmit information about an existence of the data to be transmitted to the communication node 1100 at a starting point of a duration of the selected operation slot to the communication node 1100.

When data to be transmitted by the 2^{nd} communication node 1140 does not exists during the operation slot duration of the 2^{nd} communication node 1140, the 2^{nd} communication node 1140 may transmit a no data transmission message to the communication node 1100 at the starting point of the operation slot duration of the 2^{nd} communication node 1140.

The receiving unit 1120 receives the no data transmission message from the 2^{nd} communication node 1140. The control unit 1130 deactivates the receiving unit 1120 during the operation slot duration of the 2^{nd} communication node 1140 based on the no data transmission message, and thereby may reduce power consumption.

According to an embodiment of the present invention, the 2^{nd} communication node 1140 may transmit a network address value of a 3^{rd} communication node to the communication node 1100 at the starting point of the operation slot duration of the 2^{nd} communication node 1140. The 3^{rd} communication node receives data from the 2^{nd} communication node 1140 and is located within the one-hop distance from the communication node 1100.

The receiving unit 1110 receives the network address value of the 3^{rd} communication node receiving the data from the 2^{nd} communication node 1140 during the operation slot duration of the 2^{nd} communication node 1140. The control unit 1130 may deactivate the receiving unit 1110 based on the received network address value. The control unit 1130 compares the received network address value of the 3^{rd} communication node with an address value assigned to the communication node 1100. In this instance, when the received network address value of the 3^{rd} communication node are not identical to the address value assigned to the communication node 1100, or when the assigned address value is not included in the received network address value of the 3^{rd} communication node, the control unit 1130 may determine that no data to be received exists. The control unit 1130 deactivates the receiving unit 1120 during the operation slot duration of the 2^{nd} communication node 1140, and thereby may reduce power consumption.

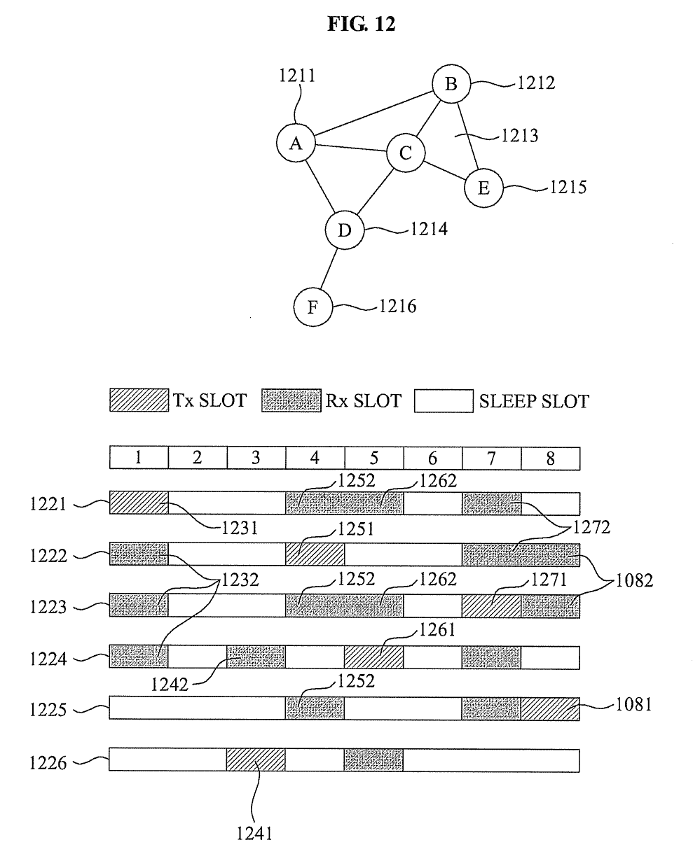

FIG. 12 is a block diagram illustrating a configuration of a mesh network transmitting data using a determined operation slot according to an embodiment of the present invention. Hereinafter, an operation of the mesh network is described in detail with reference to FIG. 12.

The mesh network includes six communication nodes. Each of the communication nodes transmits or receives data during an operation slot duration, different from each other, according to an operation slot of one-hop neighboring communication node from an operation slot of each of the communication nodes.

An operation slot of a 1^{st} communication node 1211 is a first slot 1231. A 2^{nd} communication node 1212, 3^{rd} communication node 1213, and 4^{th} communication node 1214 receive data from the 1^{st} communication node 1211 during the first slot 1231 where the 1^{st} communication node 1211 transmits the data. The 2^{nd} communication node 1212, 3^{rd} communication node 1213, and 4^{th} communication node 1214 are located within one-hop distance.

An operation slot of the 2^{nd} communication node 1212 is a fourth slot 1251. The 2^{nd} communication node 1212 transmits data in the fourth slot 1251. The 1^{st} communication node 1211, 3^{rd} communication node 1213, and 5^{th} communication node 1215 are located within a one-hop distance from the 2^{nd} communication node 1212. The 1^{st} communication node 1211, 3^{rd} communication node 1213, and 5^{th} communication node 1215 receive data from the 2^{nd} communication node 1212 in a slot 1252.

The 3^{rd} communication node 1213, 4^{th} communication node 1214, 5^{th} communication node 1215, and 6^{th} communication node 1216 are located within the one-hop distance from each other. In a same way as described above, each of the 3^{rd} communication node 1213, 4^{th} communication node 1214, 5^{th} communication node 1215, and 6^{th} communication node 1216 receives data from each of the 3^{rd} communication node 1213, 4^{th} communication node 1214, 5^{th} communication node 1215, and 6^{th} communication node 1216 in slots 1272, 1262, 1252, and 1242 during an operation slot duration 1271, 1261, 1251, and 1241 of each of the 3^{rd} communication node 1213, 4^{th} communication node 1214, 5^{th} communication node 1215, and 6^{th} communication node 1216.

Each of the 1^{st} communication node 1211, 2^{nd} communication node 1212, 3^{rd} communication node 1213, 4^{th} communication node 1214, 5^{th} communication node 1215, and 6^{th} communication node 1216 does not transmit/receive the data during an operation slot duration which is not the operation slot duration of each of the 1^{st} communication node 1211, 2^{nd} communication node 1212, 3^{rd} communication node 1213, 4^{th} communication node 1214, 5^{th} communication node 1215, and 6^{th} communication node 1216 or an operation slot duration of one-hop neighboring communication nodes. Accordingly, power consumption may be reduced. Specifically, a duty cycle of an operation slot duration, which consumes a relatively greater amount of power, of a life cycle of each of the 1^{st} communication node 1211, 2^{nd} communication node 1212, 3^{rd} communication node 1213, 4^{th} communication node 1214, 5^{th} communication node 1215, and 6^{th} communication node 1216 may be reduced. Thus, a life cycle of a communication node may increase.

According to the present invention, an access communication node connecting to a mesh network selects an operation time duration which does not collide with an operation time duration of a communication node included in the mesh network, and transmits information about the selected operation time duration to another communication node included in the mesh network.

Also, according to the present invention, an access communication node selects operation slots colliding with each other, and a communication node selects any one of a plurality of access communication nodes connecting to a mesh network in order to preferentially connect to the mesh network.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An access communication node which connects to a mesh network including a plurality of communication nodes, the access communication node comprising:
a receiving unit receiving first operation slot information of a first communication node and second operation slot information of a second communication node from the first communication node capable of directly transmitting data to the access communication node, the second communication node being capable of directly transmitting data to the first communication node and incapable of directly transmitting data to the access communication node;
a slot selection unit selecting an operation slot of the access communication node based on the first operation slot information and second operation slot information; and
a slot information transmission unit transmitting operation slot information about the selected operation slot to the first communication node.

2. The access communication node of claim 1, wherein the slot selection unit cancels the selected operation slot and reselects a new operation slot, when the selected operation slot collides with the first operation slot or second operation slot.

3. The access communication node of claim 2, wherein the slot selection unit determines that the selected operation slot collides with the first operation slot, when the receiving unit receives a beacon signal from the first communication node during a duration of the selected operation slot.

4. The access communication node of claim 2, wherein the slot selection unit cancels the selected operation slot and reselects a new operation slot, when the receiving unit receives operation slot information of a second access communication node connecting to the mesh network within an arbitrary time from a starting point of a duration of the selected operation slot.

5. The access communication node of claim 1, wherein the slot information transmission unit transmits the operation slot information about the selected operation slot, when the receiving unit does not receive operation slot information of a second access communication node connecting to the mesh network within an arbitrary time from a starting point of a duration of the selected operation slot.

6. The access communication node of claim 1, wherein the slot information transmission unit transmits a beacon signal including the operation slot information about the selected operation slot.

7. The access communication node of claim 1, wherein the slot information transmission unit periodically transmits the operation slot information about the selected operation slot.

8. The access communication node of claim 1, wherein the slot information transmission unit transmits the operation slot information about the selected operation slot to the first communication node during a first operation slot duration of the first communication node.

9. The access communication node of claim 1, wherein the receiving unit receives a noncollision confirmation message from the first communication node in response to the transmitted operation slot information, and the slot selection unit determines the selected operation slot as an operation slot of the access communication node according to the noncollision confirmation message, the non-collision confirmation message indicating that the selected operation slot does not collide with the second operation slot.

10. The access communication node of claim 1, wherein the slot selection unit cancels the selected operation slot and reselects a new operation slot, when the receiving unit does not receive a noncollision confirmation message from the first communication node in response to the transmitted operation slot information, the noncollision confirmation message indicating that the selected operation slot does not collide with the second operation slot.

11. The access communication node of claim 1, wherein the slot selection unit cancels the selected operation slot and reselects a new operation slot, when the receiving unit receives a collision confirmation message in response to the transmitted operation slot information.

12. A communication node included in a mesh network, the communication node comprising:
an operation slot information transmission unit directly transmitting operation slot information about an operation slot of the communication node to a first access communication node;
a receiving unit receiving first operation slot information about an operation slot selected by the first access communication node from the first access communication node based on the transmitted operation slot information;
a selected slot control unit comparing the first operation slot information with second operation slot information about an operation slot selected by a second access communication node, the second access communication node being capable of directly receiving data from the communication node and incapable of directly receiving the data from the first access communication node; and
a transmission unit transmitting a noncollision confirmation message to the first access communication node based on a result of the comparing.

13. The communication node of claim 12, wherein the operation slot information transmission unit directly transmits operation slot information of a second communication node to the first access communication node, and the first operation slot information is selected based on the operation slot information of the second communication node, the second communication node being capable of directly transmitting data to the communication node and incapable of directly transmitting data to the first access communication node or second access communication node.

14. The communication node of claim 12, wherein the receiving unit receives the first operation slot information during an operation slot duration of the communication node.

15. The communication node of claim 12, wherein the selected slot control unit selects any one of the first access communication node and second access communication node as a preferential access node, when an operation slot selected by the first access communication node and an operation slot selected by the second access communication node collide, and the transmission unit transmits the non-collision confirmation message to the selected preferential access node.

16. The communication node of claim 15, wherein the receiving unit receives a network address value from each of the first access communication node and second access communication node, and the selected slot control unit selects the preferential access node based on the network address value.

17. The communication node of claim 12, wherein the transmission unit transmits a collision confirmation message to the second access communication node, the collision confirmation message indicating to cancel the selected operation slot and reselect a new operation slot based on a result of the comparing.

18. A mesh network including a plurality of communication nodes, the mesh network comprising:
a first access communication node and second access communication node connecting to the mesh network; and
a communication node selecting a preferential access node from the first access communication node and second access communication node and transmits a noncollision confirmation message to the preferential access node, when an operation slot selected by the first access communication node and an operation slot selected by the second access communication node collide,
wherein an access communication node receiving the noncollision confirmation message transmits data to the communication node during a duration of the selected operation slot according to the noncollision confirmation message.

19. The mesh network of claim 18, wherein the first access communication node cancels the selected operation slot and reselects an operation slot when the non-collision confirmation message is not received.

20. A communication node included in a mesh network, the communication node comprising:
a transmission unit transmitting first data to a second communication node capable of directly receiving data from the communication node during an operation slot duration of the communication node; and
a receiving unit receiving second data from the second communication node during an operation slot duration of the second communication node.

21. The communication node of claim 20, further comprising:
a control unit deactivating the transmission unit and receiving unit during an operation slot duration excluding the operation slot duration of the communication node or the operation slot duration of the second communication node.

22. The communication node of claim 20, wherein the transmission unit transmits the first data to the second communication node during the operation slot duration of the second communication node.

23. The communication node of claim 20, wherein the receiving unit receives a no data transmission message from the second communication node during the operation slot duration of the second communication node, and
the communication node further comprises a control unit deactivating the receiving unit based on the received no data transmission message.

24. The communication node of claim 20, wherein the receiving unit receives a network address value of a third communication node from the second communication node during the operation slot duration of the second communication node, and
the communication node further comprises a control unit deactivating the receiving unit based on the received network address value.
